(19) United States
(12) Patent Application Publication
(10) Pub. No.: US 2009/0145120 A1
(43) Pub. Date: Jun. 11, 2009

(54) METHOD AND CIRCUIT ARRANGEMENT OF THE SUPPLY OF PRESSUE MEDIUM TO AT LEAST TWO HYDRAULIC CONSUMERS

(75) Inventors: Hans Esders, Hildesheim (DE); Stephan Kaiser, Neumunster (DE)

Correspondence Address: ZARLEY LAW FIRM P.L.C., CAPITAL SQUARE, 400 LOCUST, SUITE 200, DES MOINES, IA, 50309-2350, US

(73) Assignee: SAUER-DANFOSS INC., Ames, IA (US)

(21) Appl. No.: 12/247,258

(22) Filed: Oct. 8, 2008

(30) Foreign Application Priority Data
Dec. 11, 2007 (DE) 10 2007 059 491.9

(51) Int. Cl. F15B 13/06

(52) U.S. Cl. 60/422

(57) ABSTRACT

The invention relates to a method and a circuit arrangement for controlling and regulating the supply of pressure medium to at least two hydraulic consumers, which are assigned in each case a directional valve for setting the flow and a setpoint signal source, by means of a pump with a variable displacement, which can be regulated by means of a displacement controller. The pump displacement is regulated according to the flow required by the setpoint signals. The individual load pressure of the consumers and of the consumer having the highest load pressure are determined. The directional valve of the highest loaded consumer is controlled to a valve-spool position y₁, with y₁=K·y_{1,max}=const., which lies by a factor K, with 0<K<1, below the valve-spool position y_{1,max} representing the maximum opening of the directional valve. This control of the directional valve of the highest loaded consumer has superposed on it at least one dynamic subcontroller which smoothes out pressure fluctuations via the residual opening of the directional valve remaining between the valve-spool positions y₁ and y_{1,max}.

### BACKGROUND OF THE INVENTION

The invention relates to a method for the supply of pressure medium to at least two hydraulic consumers according to Claim 1 and to a circuit arrangement according to Claim 15.

In electronically implemented load-sensing (LS) systems for the supply of a plurality of hydraulic consumers, the energy efficiency can not only be improved by lowering the LS pressure difference. The control strategy can, furthermore, be modified such that the valve assigned to the currently highest loaded consumer is opened fully and the pump is regulated to a displacement, which, at the current rotational speed, satisfies the volume flow requirement of all the consumers. In the case of the further consumers, for example, an individual pressure balance then ensures that these do not consume more than the volume flow pertaining to them. Systems of this type are known from DE 103 40 993 A1 or EP 1 664 551 A1.

In the known systems, although it is possible to minimize energy losses, there is also nevertheless the disadvantage that the highest loaded consumer is controlled by the displacement of the variable-displacement pump. However, in comparison with valve controls, pump displacement controls have, relatively low dynamics, resulting in undesirable consequences. Thus, sudden fluctuations in the load pressure of the consumer subjected to the highest load can be smoothed out only inadequately. Moreover, load-pressure fluctuations of consumers subjected to lower load may penetrate to the pump side in spite of high-speed individual pressure balances. If these consumers have very low time constants, as is the case, for example, in motors with low mass inertia and short hydraulic lines, an influencing of the pump pressure then cannot be avoided entirely. In this case, too, the disturbance at the consumer subjected to the highest load can then be smoothed out only inadequately slowly by means of sluggish pump adjustment. Furthermore, the highest loaded consumer changes during operation. This means that, for all consumers which may possibly be at any one time the highest loaded consumer, two completely different control schemes are activated which use actuators of varying dynamics. This leads, at the operator, to a different feeling in the actuation of a consumer, depending on whether the consumer is or is not the highest loaded one.

The aim of the invention is to provide an improved supply of pressure medium to a plurality of consumers.

### SUMMARY OF THE INVENTION

According to the invention, this is achieved by means of a method for controlling and regulating the supply of pressure medium to at least two hydraulic consumers, which are assigned in each case a directional valve for adjusting the flow and a source of a setpoint signal, and a pump with a variable displacement, which can be regulated by means of a displacement controller. The method comprises the method steps:
a) control of the pump displacement according to the volume flow required by setpoint signals;
b) detection of the individual load pressure of the consumers;
c) determination of the consumer having the highest load;
d) control of the directional valve of the consumer having the highest load to a valve-spool position y₁, with y₁=K·y_{1,max}=const., which lies by a factor K, with 0<K<1, below the valve-spool position y_{1,max} representing the maximum opening of the directional valve;
e) superposition of the control of the directional valve of the consumer having the highest load by at least one dynamic subcontroller which smoothes out pressure fluctuations via the residual opening of the directional valve remaining between the valve-spool positions y₁ and y_{1,max}.

It is therefore proposed, in the system described in the introduction, to depart somewhat from the aim of maximum energy saving and not to open completely the valve belonging to the consumer having the highest load, but, instead, to open it only to a large extent. Fixing the operating point of the valve in this way below its full opening creates an, albeit minor, inflow pressure difference. The directional valve with its good dynamics is then available as an actuator and can compensate disturbances using the remaining residual opening. Setpoint changes, must, of course, continue to be compensated by the displacement control of the pump which also ensures the stationary accuracy of the volume flow.

It is advantageous if, in addition, maximum-pressure control is provided, which, when a preset pressure is reached, overrides the displacement control of the pump. The displacement is thereby set such that the maximum pressure is held, but is not overshot.

Preferably, a dynamic subcontroller is assigned to the consumer valve on the load side. At increasing pressure in the load line, its output is superposed additively to the valve signal in a way, that the spool position is increasing. Thus, sudden load changes will be compensated directly at the valve. If another dynamic subcontroller is added to the valve on the pump side, also pressure disturbances will be compensated which are caused by load changes at one of the other consumers. The output of this second subcontroller is superposed subtractively to the valve signal, so that the valve opening is decreasing when the pump pressure is rising. Thus the mutual influencing of various simultaneously operated consumers can be minimized. These dynamic subcontrollers preferably react to the rate of pressure change. If the pressure does not change or changes only slowly, the output signal from the subcontrollers is zero. Pressure peaks occurring generate an output signal which is superposed on that of the stationary-value control element of the valve control and which therefore smoothes out the pressure peaks directly at the directional valve. The dynamic subcontrollers are parameterizable and consequently adaptable to the individual time constants of different consumers.

The factor K for various consumers is to be dimensioned differently, dependent on their practical requirements. An optimal compromise between energy efficiency and dynamics can thereby be set. It is particularly advantageous if the factor K can be varied during the continuous operation of the appliance, so that changing requirements can be fulfilled during practical operation. Such adjustment may take place, for example, by hand or else automatically according to the current pressure level and/or the currently required volume flow. The system can consequently be designed adaptively since the controllers are designed identically for all consumers and no structural changes are required for different operating modes. The individual setting for the respective consumers occurs solely by varying the K value. This adaptation may likewise advantageously take place according to the current pump speed, the travel-drive control, the currently actuated consumers, the selected operating mode and/or the present oil temperature.

The invention relates, furthermore, to a circuit arrangement for controlling and regulating the supply of pressure medium to at least two hydraulic consumers, which are assigned in each case an electrically actuateable directional valve for flow control and a setpoint signal source. The circuit arrangement comprises also a pump with a displacement controller, adjusting the displacement according to the flow required by the setpoint signals of all consumers. The circuit comprises also a device for determining the consumer having the highest load and a control unit which controls the directional valve of the consumer having the highest load to a spool position y₁. The spool position y₁=K·y_{1,max}=const. lies by a factor K, with 0<K<1, below the spool position y_{1,max} representing the maximum opening of the directional valve. The circuit arrangement comprises also at least one dynamic subcontroller which is superposed on the control unit and smoothes out pressure fluctuations via the residual opening of the directional valve remaining between the valve-slide positions y₁ and y_{1,max}. By means of the dynamic subcontroller, sudden pressure fluctuations are not smoothed out at the pump, but only at the directional valve, while pump adjustment serves merely for virtually stationary supply as a function of the setpoint signals and the pump speed.

Further features and advantages of the invention may be gathered from the following figure description.

### BRIEF DESCRIPTION OF THE FIGURE

FIG. 1 is a schematic drawing of a hydraulic circuit.

### DETAILED DESCRIPTION OF THE PREFERRED EMBODIMENT

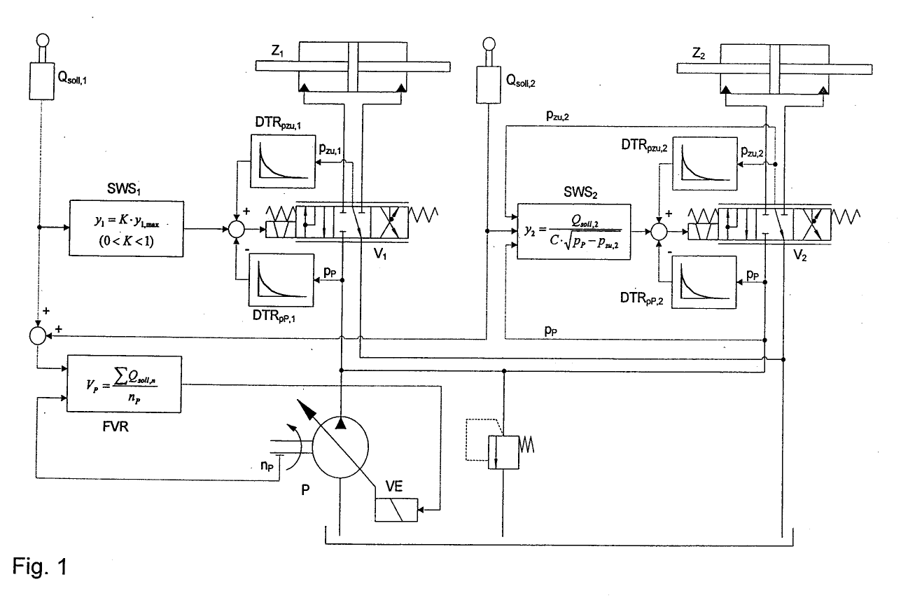

FIG. 1 shows an exemplary embodiment of the invention. The essential elements of the hydraulic circuit and of the electronic signal flow are in this case illustrated jointly, specifically by the example of two consumers, of which the first consumer Z₁ stands for that with the highest load pressure and the second consumer Z₂ represents, where appropriate, a plurality of consumers having a lower load pressure.

A pump P, driven for example by a diesel engine, not illustrated, rotates at the rotational speed n_{P}. The pivot angle (and thus the displacement volume) of the pump P can be controlled via an electrically actuatable adjustment device VE. This regulation takes place by means of the displacement controller FVR according to the sum of the required flows Q_{S011,1}, and Q_{S011,2} the displacement volume of the pump V_{P} being regulated, taking into account the rotational speed of the pump n_{P}, to

$${V}_{P} = \frac{\sum {Q}_{soll , n}}{{n}_{P}}$$

This setup allows to adjust flow and pressure in quasi-stationary operation according to the individual requirements of a plurality of consumers. Due to the inertia of the pump adjustment, however, rapid pressure fluctuations cannot be smoothed out satisfactorily. These pressure fluctuations occur frequently during the operation of the hydraulic consumers due to changing loads. For this purpose, the system according to the invention is provided at the directional valves V₁, V₂ of the individual consumers, because these directional valves can react far more quickly when pressure peaks occur.

First, in the figure, the control of the supply of the consumer Z₂ having a lower load will be explained. A corresponding circuit of course must be provided for all consumers which, at any one time during operation, may not be the consumer subjected to the highest load. The flow Q₂ to the consumer Z₂ is obtained from the flow equation of the valve V₂ as

Q₂=y₂·C·\sqrt{p_{P}−p_{zu,2}}

in which y₂ is the spool position, C is a constant, p_{P} is the pump pressure and P_{zu,2} is the inflow-side pressure to the consumer Z₂. Solving the equation for the spool position y₂ yields the formula shown in the steady state controller SWS₂. The output of the steady state controller SWS₂ is based on the setpoint signal, and the pressure signals p_{P} and P_{zu,2} before and after the valve on the inflow path to consumer Z₂.

$${y}_{2} = \frac{{Q}_{soll , 2}}{C \cdot \sqrt{{p}_{P} - {p}_{zu , 2}}}$$

In steady state, therefore, the valve spool position is predetermined and is fixed unequivocally. It remains unchanged as long as the steady state situation does not change. The steady state controller SWS₂cannot act in the manner of a closed loop controller, it cannot process any difference between setpoint value and actual value and it also is not parameterizable.

To smooth out rapid pressure fluctuations, the dynamic subcontrollers DTR_{pzu,2} and DTR_{P}p,₂ are provided. They can react to pressure fluctuations on the load or pump side and by quickly changing the valve spool position, typically within less than ls, they can consequently improve the dynamic behaviour of the supply. These dynamic subcontrollers are designed in the exemplary embodiment of the figure as DT₁-elements. They react to the rate of pressure change. Their outputs are zero when the pressure no longer changes or changes only slowly. In the event of a rapid pressure rise on the load side, which cannot be compensated by the steady state controller SWS₂ nor by the displacement controller FVR, the signal of the dynamic subcontroller DTR_{pzu,2} is added to the signal of the steady state controller SWS₂ and thereby is superposed on the control of the valve spool position y₂ with the effect of enlarging the valve opening.

The situation is the opposite on the pump side. Here, above all, the mutual influencing of the consumers is to be avoided. Here, an instantaneous pressure rise leads to the valve opening being reduced, and therefore the signal of the pump-side dynamic subcontroller DTRp,₂ is superposed subtractively on the control by the steady state controller SWS₂. In the case of sudden pressure drops, of course, the behaviour is the opposite in both instances.

The described combination of the additive superposition of the load-side subcontroller and subtractive superposition of the pump-side subcontroller may also advantageously be reversed in specific instances. If, for example, the inlet metering edge is opened very wide, a penetration of a load-side disturbance to the pump side is in any case not entirely avoidable. In this case, it would be advantageous if the load-side subcontroller already acts subtractively and consequently initiates the reaction which is in any case caused shortly thereafter by the pump-side subcontroller.

An additive superposition of the pump-side subcontroller may, under certain circumstances, also make sense, for example when the hydraulic flexibility of the pump line is much greater than that of the load line. This may be the case in working machines which have a work platform rotatable against the undercarriage. Here, often, the drive assembly, including the pump, is located in the undercarriage and the valves in the platform. This helps to keep the number of lines low, which need to be led through the rotational joint. In a system of this type, pressure changes in the compliant pump line would cause far more vigorous reactions in the comparatively rigid load line. It may make sense here, according to the abovementioned strategy, to initiate at an early stage on the pump side the reaction which is in any case caused a short time later on the load side.

For the highest loaded consumer Z₁, the control of the directional valve V₁ takes place by means of the steady state controller SWS₁, whose signal is superposed by the signal of the dynamic subcontrollers DTR_{pzu,1} and DTR_{P}p,₁, as described above. According to the invention, however, in this case the directional valve V₁ does not open according to the required Q_{des,1}, but, instead, is opened to a fixed value which forms the operating point of the valve. The valve spool, although opening substantially, nevertheless remains below the maximum by a factor K. The valve-spool position y₁ is accordingly determined as

y₁=K·y_{1.max}

with

0<K<

where y_{1.max} represents the maximum opening of the directional valve V₁ of the consumer Z₁ having the highest load.

Thus, between y₁ and the maximum opening y_{1.max}, a residual opening remains which according to the present invention is utilized for smoothing out rapid pressure fluctuations. Consequently, also in the case of the consumer Z₁ having the highest load, the dynamic subcontrollers DTR_{pzu,1} and DTR_{P}p,₁ may be permanently active.

The relevant consumers Z₁, Z₂, etc. may not necessarily be synchronous cylinders, as illustrated in FIG. 1. Depending on the field of use, they may also be designed as differential cylinders, hydraulic motors and the like. The variety of possible hydraulic working applications with different requirements can be taken into account by the selection of the operating point y₁, that is to say of the factor K, the selection of which ultimately means a compromise: The further open (K→1) the directional valve V₁ is, the higher the efficiency is or the lower the energy losses are, but the poorer are also the possibilities of smoothing out disturbance variables dynamically. A particular advantage of the invention is that the constant K and therefore the operating point can be fixed individually for the individual consumers.

The selection of the factor K is explained below by means of some examples:
A fork-lift truck lifts the partially loaded fork at high speed. At the same time, the steering is actuated in the stationary vehicle. Both functions are supplied by the same variable-displacement pump. The steering is the consumer subjected to the higher load. No load disturbances are to be expected here. It is also highly unlikely that load disturbances occur on the lifting cylinder of the fork, since the operator has a constant view of the fork and, if appropriate, would sharply reduce the lifting speed. Low-frequency oscillations may be excited, at most, due to the mass inertia of the load and may possibly be propagated to the pump side. K should here be set in the range of 0.85 to 0.95, preferably to 0.9. The remaining opening margin is then sufficient to ensure that the dynamic subcontrollers at the steering valve can compensate such oscillations.
An excavator is digging out a pit. This kind of work always involves a plurality of consumers, such as boom, arm and bucket, which are in use simultaneously. Moreover, the consumer in each case subjected to the maximum load often changes. Since digging-out is relatively rough work in which some mutual influencing of the consumers can be accepted, a K of 0.85 to 0.9 is likewise expedient here in spite of the expected considerable load fluctuations.
If the excavator has completed most of the excavation and is to draw the walls of the pit, accurate track guidance is then required. Mutual influencing is undesirable. A K of approximately 0.8 would be appropriate here in order to increase the valve spool opening margind for actions of the dynamic subcontroller.
In order to empty the bucket of a wheel loader of sticky excavated material completely, a vibrating function is required: A vibrating movement of low amplitude and of as high a frequency as possible is to be superposed on the opening stroke of the bucket cylinder. In conventional load-sensing operation, this is possible only to a highly restricted extent, since, even in the case of the fastest possible pump displacement control, only a low vibrating frequency is obtained. A substantially higher frequency can be achieved if the vibrating function is implemented by means of the valve of the shovel cylinder while the pump adjustment meets only the average volume flow requirement. In conventional load-sensing systems, this is achieved by means of a mode changeover in which the pump is changed over from load-sensing operation to constant-pressure operation. In the supply according to the invention, a very low K value of, for example, 0.4 may be suitable for this purpose. In this case, the pressure in the supply line will rise sharply because the requested pump flow otherwise cannot pass the narrowed valve opening. The pump then changes automatically over to maximum-pressure control operation while the vibration excitation is superposed on the valve signal. The special function in question is consequently brought about by means of the present invention without any complicated mode changeover.

The system behaviour may be set continuously between “high efficiency with poor dynamics” and “low efficiency with good dynamics”. The factor K alone serves for setting. The overall controller structure and parameterization remain unchanged. The K-value may in this case be predetermined individually for each consumer in the associated controller system. It is also appropriate, however, to provide the possibility of adjustment during continuous operation. This may be implemented by means of a manually actuateable switch, for example an incremental switch, by means of which the K-value can be varied in specific steps within a range. In another development of the invention, setting takes place automatically as a function of the current pressure level and/or of the currently required flow. This would take, into account the fact that, in the case of a high required hydraulic power, the operator has a different expectation as to the accuracy of the track guidance of the actuators from that in the case of low power.

However, the pump speed may also advantageously be included in the automatic determination of the K-value, since this gives information on the actually available power. If, during operation, there is also information on the current driving state of the vehicle (for example, from the control of the hydrostatic propel drive of a forestry machine or the power-shift transmission of a tractor), then this information is, of course, also of great assistance in determining the optimal K-value. Thus, for example, forestry forwarders load up the logs scattered on the ground partially at a standstill, but partially also during a slow drive movement. In the latter case, of course, a much higher accuracy of track guidance of the crane is required, in order to avoid collisions with the trees which have not been felled and between which the cut-down pieces have to be “fished out”. This must be taken into account via a very high K-value and the resulting minimal mutual influencing.

On many working machines, there are nowadays already mode switches, by means of which the same job can be carried out in different operating modes (“maximum power”, “noise-reduced with reduced engine speed”, etc.). In specific modes, in this case, even individual consumers are switched off entirely. Information on the selected mode and on the actually activatable consumers may, of course, likewise advantageously be included in the setting of the K-value.

Another important parameter is the oil temperature. As is known, the oil viscosity and consequently the friction in the individual components of the hydraulic system are highly temperature-dependent. Friction, in turn, decisively influences the damping of the overall system. By means of a low K-value, low system damping due to temperature can be reacted upon, since a smaller valve opening is a pre-condition for a damping-increasing parameterization of the electronic controllers.

Various alternatives to the elements illustrated in the exemplary embodiment of FIG. 1 are possible. Thus, the metering of the individual consumer flow may also be implemented by two 3/2-way proportional valves or by four 2/2-way proportional valves instead of by means of the 4/3-way proportional valve.

Valves may also be equipped directly with two pressure sensors, one each for each working connection. A pressure pick-up “behind the meter-in control edge”, as shown in FIG. 1, is then of course no longer available. Which of the two pressure signals is present behind the current meter-in control edge and which is present in front of the current meter-out control edge can then be determined in a simple way by means of the sign of the setpoint signal.

The invention forms an improved system for the supply of a plurality of hydraulic consumers, in that the valve of the consumer having the highest load is set, taking into account an additional power loss fraction, at an operating point which corresponds to a wide, but not complete, opening of the valve. The remaining residual opening serves for compensating rapid pressure fluctuations by means of dynamic subcontrollers. The opening of the valve is therefore not adjusted proportionally to the desired flow, as is the case in conventional hydraulic or electronic load-sensing systems.

Dynamic disturbances are compensated only at the consumer valves, not at the pump. At this it is to be assumed that such disturbances are caused primarily by sudden load changes at the consumers. If compensation is not entirely successful at the consumer valves, they also cause oscillations of the pump pressure (secondary disturbance). As a result, even in the case of other consumers, dynamic disturbances occur, although these have themselves not experienced any load change at all. Both types of disturbances are compensated according to the invention solely at the consumer valves. All controller parameterizations are in this case assigned permanently to the respective components. It is not necessary, as is customary, always to change over to a new parameter set for the pump controller when the highest loaded consumer changes. Only the factor K at the valve of the highest loaded consumer serves for setting, while the overall controller structure and parameterization otherwise remain unchanged.

I claim:

1. Method for controlling and regulating the supply of pressure medium to at least two hydraulic consumers, which are assigned in each case a directional valve (V₁, V₂) for setting the flow and a source of a setpoint signal (Q_{so11,1}, Q_{so11,2}), and a pump (P) with a variable displacement, which can be regulated by means of a displacement controller (FVR), with the method steps:
a) regulation of the pump (P) according to the flow required by the setpoint signal sources (Q_{so11,1} Q_{so11,2});
b) detection of the individual load pressure (P_{zu,1}, P_{zu,2}) of the consumers (Z₁, Z₂)
c) determination of the consumer (Z₁) having the highest load;
d) control of the directional valve (V₁) of the highest loaded consumer (Z₁) to a valve-spool position y₁, with y₁=K·y_{1,max}=const., which lies by a factor K, with 0<K<1, below the valve-spool position y_{1,max} representing the maximum opening of the directional valve (V₁)
e) superposition of the control of the directional valve (V₁) of the highest loaded consumer (Z₁) by at least one dynamic subcontroller (DTR_{pzu,1} and DTR_{P}p,₁) which compensates pressure oscillations via the residual opening of the directional valve (V₁) remaining between the valve-slide positions y₁ and y_{1,max}.

2. Method according to claim 1, in which the regulation of the pump (P) is overridden by a maximum pressure control when the pressure exceeds a preset pressure value.

3. Method according to claim 1, in which the dynamic subcontroller (DTR_{pzu,1}) is assigned to the directional valve (V₁) on the consumer side, and, when pressure changes occur in the line to the consumer, its output is superposed on the control of the directional valve (V₁)

4. Method according to claim 1, in which the dynamic subcontroller (DTR_{pzu,1}) is assigned to the directional valve (V₁) on the pump side and, when pressure changes occur in the pump line, its output is superposed on the control of said directional valve.

5. Method according to claim 1, in which the dynamic subcontroller (DTR_{pzu,1} and DTR_{P}p,₁) reacts to a rate of pressure change.

6. Method according to claim 1, in which the factor K is dimensioned differently for different consumers.

7. Method according to claim 1, in which the factor K can be varied during the operation of the supply.

8. Method according to claim 7, in which the factor K is adjustable by hand.

9. Method according to claim 7, in which the factor K is adjustable automatically.

10. Method according to claim 9, in which the factor K is adjusted according to the current pressure level and/or the currently required flow.

11. Method according to claim 9, in which the factor K is adjustable according to the current pump speed.

12. Method according to claim 9, in which the factor K is adjustable according to the propel drive control.

13. Method according to claim 9, in which the factor K is adjustable according to the currently actuated consumer and/or the currently set operating mode.

14. Method according to claim 9, in which the factor K is adjustable according to the current oil temperature.

15. Circuit arrangement for controlling and regulating the supply of pressure medium to at least two hydraulic consumers, which are assigned in each case an electrically actuateable directional valve (V₁, V₂) for setting the flow and a setpoint signal source (Q_{des1}, Q_{des2}), and a pump (P) with a variable displacement, which can be regulated by means of a displacement controller (FVR), according to the flow required by the setpoint signal sources (Q_{so11,1}, Q_{so11,2}), and also with a device for determining the consumer (Z₁) having the highest load and with a control unit which controls the directional valve (V₁) of the highest loaded consumer (Z₁) to a valve-spool position y₁, with y₁=K·y_{1,max}=const., which lies by a factor K, with 0<K<1, below the valve-spool position y_{1,max} representing the maximum opening of the directional valve (V₁), and also with at least one dynamic subcontroller (DTR_{pzu,1} and DTR_{P}p,₁) which is superposed on the control unit and compensates pressure fluctuations via the residual opening of the directional valve (V₁) remaining between the valve-spool positions y₁ and y_{1,max}.

16. Circuit arrangement according to claim 15, in which the displacement controller (FVR) of the pump (P) is overridden by a maximum-pressure controller when the pressure exceeds a preset pressure value.

17. Circuit arrangement according to claim 15, in which the dynamic subcontroller (DTR_{pzu,1}) is assigned to the directional valve (V₁) from the consumer side and, when pressure changes occur in the line to the consumer (Z₁), its output is superposed on the control of the directional valve (V₁).

18. Circuit arrangement according to claim 15, in which the dynamic subcontroller (DTR_{P}p,₁) is assigned to the directional valve (V₁) on the pump side and, when pressure changes occur in the pump line, its output is superposed on the control of said directional valve.

19. Circuit arrangement according to claim 15, in which the dynamic subcontroller (DTR_{pzu,1} and DTR_{P}p,₁) reacts to a rate of pressure change.

20. Circuit arrangement according to claim 15, in which the factor K is dimensioned differently for different consumers.

21. Circuit arrangement according to claim 15, in which a setting device is provided, by means of which the factor K can be adjusted for the individual consumers during continuous operation.

22. Circuit arrangement according to claim 21, in which the setting device can be operated by hand.

23. Circuit arrangement according to claim 21, in which the setting device adapts the factor K automatically according to the current pressure level and/or the currently required flow.

24. Circuit arrangement according to claim 23, in which the setting device adapts the factor K according to the current pump speed.

25. Circuit arrangement according to claim 23, in which the setting device adapts the factor K according to the propel drive control.

26. Circuit arrangement according to claim 23, in which the setting device adapts the factor K according to the currently actuated consumer and/or the currently set operating mode.

27. Circuit arrangement according to claim 23, in which the setting device adapts the factor K according to the current oil temperature.
